(19) United States
(12) Patent Application Publication
(10) Pub. No.: US 2003/0037817 A1
(43) Pub. Date: Feb. 27, 2003

(54) High-speed water jet blocker

(75) Inventors: Norman A. Rudy, Snohomish, WA (US); Erich W.A. Wiesinger, Issaquah, WA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: FMC Technologies, Inc

(21) Appl. No.: 09/935,127

(22) Filed: Aug. 21, 2001

(51) Int. Cl. F16K 49/00

(52) U.S. Cl. 137/338

(57) ABSTRACT

An apparatus and method for performing high-speed interruption of a high-speed fluid stream of the type used for cutting and particularly suited to cutting operations in the food services industry. The water blocker includes a housing (110) having a motor cavity (112), a motor (140), and a projecting portion (162) that is adapted to receive a conduit (95) supplying the fluid stream. The motor is drivably connected to a wheel (180) having a plurality of blocker pins (190). The blocking pins are aligned to selectively intersect the high pressure fluid stream. A programmable computer (149) controls the motor.

### FIELD OF THE INVENTION

This invention relates generally to a product cutter utilizing a high pressure fluid stream and, more particularly, to methods and apparatus for selectively interrupting the flow of a stream of high pressure water used in cutting applications.

### BACKGROUND OF THE INVENTION

High-speed fluid jets have been used to cut food, paper, and other products for years. The advantages are numerous: there are no blades that present a safety concern and that need to be regularly sharpened or replaced, minimal dust or other airborne particulates are generated, and the cutting process can be quick, flexible, and clean. The cutting is accomplished with a thin, high velocity stream of water or other fluid. Pressurized water is ejected from a small orifice to create the stream or jet of liquid. When the jet impinges on the target product, a thin slice of material is removed, typically without any appreciable water being absorbed into the product.

Specific manipulation and interruption of the high-speed water jet, frequently under precise computer control, accurately cuts shapes in the products. Many of the desired cutting operations require precise high-speed interruption of the water jet. Generally, the greater the detail of the desired cutting operation, the faster the interruption of the jet must be in order to attain such detail. The overall speed of a cutting operation is frequently limited by the rate at which the high-speed stream can be controllably interrupted. A higher rate of water stream interruption, therefore, may reduce the overall product processing time required.

Various methods and apparatus have been taught to controllably interrupt a high-speed water jet. One such method of interruption is to use a linear actuator to insert an object between the high-speed water jet and the product. Typically, a pneumatic linear actuator forces a blocker pin into the path of the water jet to interrupt the flow of the cutting stream and a spring provides a retracting force for the plunger pin. Existing pneumatic blocker pin devices are capable of reaching closure times of 50-90 ms and thereby limit the speed at which products may be cut by the water jet.

U.S. Pat. No. 4,693,153 (Wainwright et al.) discloses another water jet interruption technique. When interruption of the high-speed water jet is desired, a second high pressure fluid is directed at the object cutting jet so as to disperse the latter and impair its cutting properties. The device that controls the second fluid flow is similar to the plunger pin device. A solenoid device within the jet obstructer device controls the fluid flow from the jet obstructer device. An energized solenoid closes a plunger mechanism that is normally held in an open position by a spring. In the open position the mechanism provides high pressure fluid to interrupt the object-cutting water jet. Similar to the plunger pin device, this device also lacks the high-speed interruption capabilities necessary for cutting products as rapidly as may be desired.

International Patent Application No. WO93/10950 discloses a valve for controlling a constantly running liquid cutting jet. A pneumatically powered rotary cylinder 2 is attached to one end of and elongate plate 1 to rotate the opposite end of the plate in and out of the path of flow of the liquid cutting jet. However, the opening and closing times for this rotary plate are only slightly better than that of existing plunger pin devices. Also, the cutting jet strikes one position on the plate resulting in frequent replacement of the plate.

A pivoting pin interruption mechanism is taught in U.S. Pat. Nos. 5,931,178 and 5,927,320 to Pfarr et al., and owned by the assignee of the present application. Pfarr et al. discloses a water jet blocking device that utilizes a blocking pin having a first end attached to a rotary actuator and a second end that is disposed near a high-speed fluid jet. The actuator pivots the blocking pin about a center fulcrum, such that the second end of the blocking pin can be selectively moved to block the high-speed jet stream. The pivoting pin interruption mechanism overcomes many of the disadvantages of the prior art, permitting faster activation times and a durable apparatus. However, further improvements in activation time and durability remain desirable. Accordingly, the present invention provides significant advantages over previous devices or methods controllably block highspeed fluid jets.

### SUMMARY OF THE INVENTION

The present invention is directed to a water blocker for a high pressure water jet that provides very high-speed switching between the blocking mode and the unblocked mode. The invention is particularly suitable for water jet cutting applications in the food processing industry, although other applications are contemplated as well.

In accordance with this invention, a method and apparatus for controlling the flow of a stream of high pressure fluid is disclosed. The apparatus includes a main housing adapted to receive a conduit providing a high-pressure fluid stream with an aperture aligned with the high pressure fluid stream. A motor attached to the housing is drivably attached to a blocker wheel assembly having a plurality of radially-projecting, spaced-apart blocking pins. The blocker wheel is disposed next to the housing such that rotation of the wheel will cause the blocking pins to move in an arc intersecting the high-speed fluid stream.

In one embodiment of the present invention, the motor is controlled by a programmable computer.

In an embodiment of the invention, the motor is disposed within a cavity in the housing assembly, thereby protecting the motor from the fluid stream. A source of pressurized cooling air is directed around the motor to provide convective cooling, and an air exit channel is provided in the housing for exhausting the high pressure cooling air.

In an embodiment of the invention, a tubular cooling sleeve is disposed around the motor, wherein the cooling sleeve has a pair of outwardly projecting flanges that cooperate with the housing to form an annular channel around the motor through which the cooling air is directed.

In an embodiment of the invention, the blocker wheel is drivably connected to the motor through a gear assembly that includes a master gear connected to the motor and a slave gear connected to the blocker wheel.

In an embodiment of the invention, the blocker wheel includes at least 16 blocking pins.

### BRIEF DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a side cross-sectional view of an embodiment of a water blocker according to the present invention.

FIG. 2 is an exploded view of the water blocker shown in FIG. 1.

FIG. 3 is sectional plan view of the water blocker shown in FIG. 1 through section 3-3.

FIG. 4 is a plan view of the blocker wheel shown in FIG. 1.

FIG. 5 is a cross-sectional view of the blocker wheel for the water blocker shown in FIG. 1 through section 5-5.

FIG. 6 is a block diagram showing the water blocker of FIG. 1 connected to a programmable controller.

### DETAILED DESCRIPTION OF THE PREFERRED EMBODIMENT

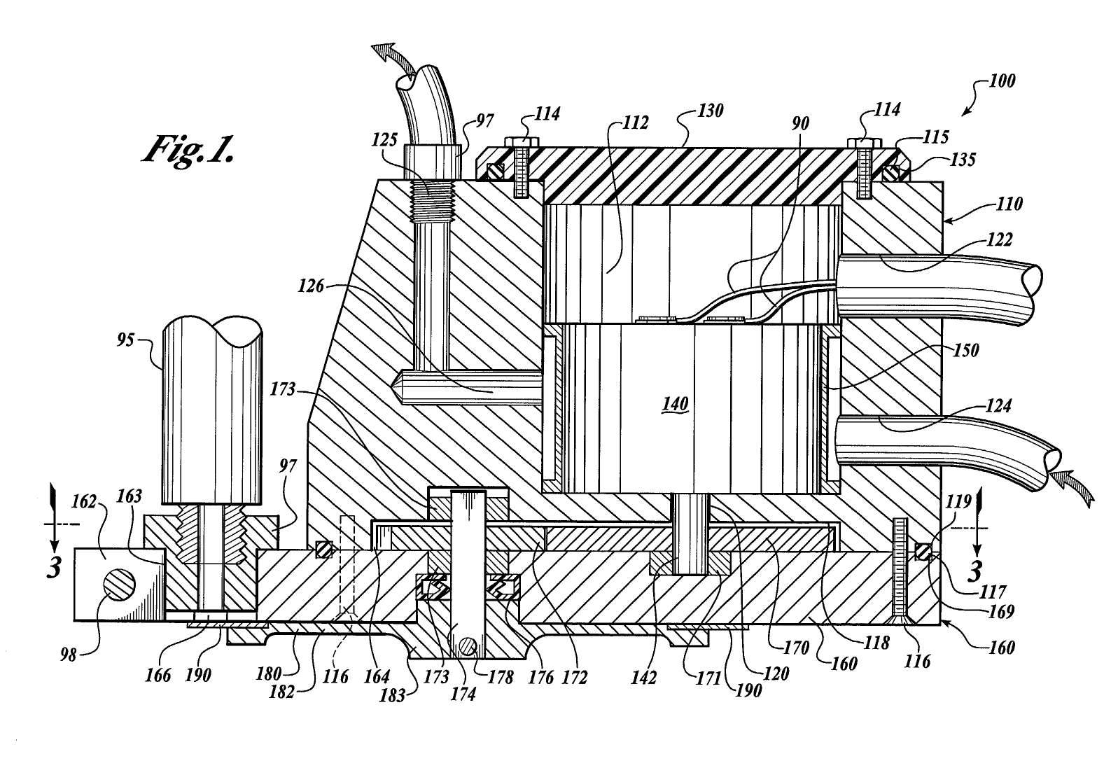

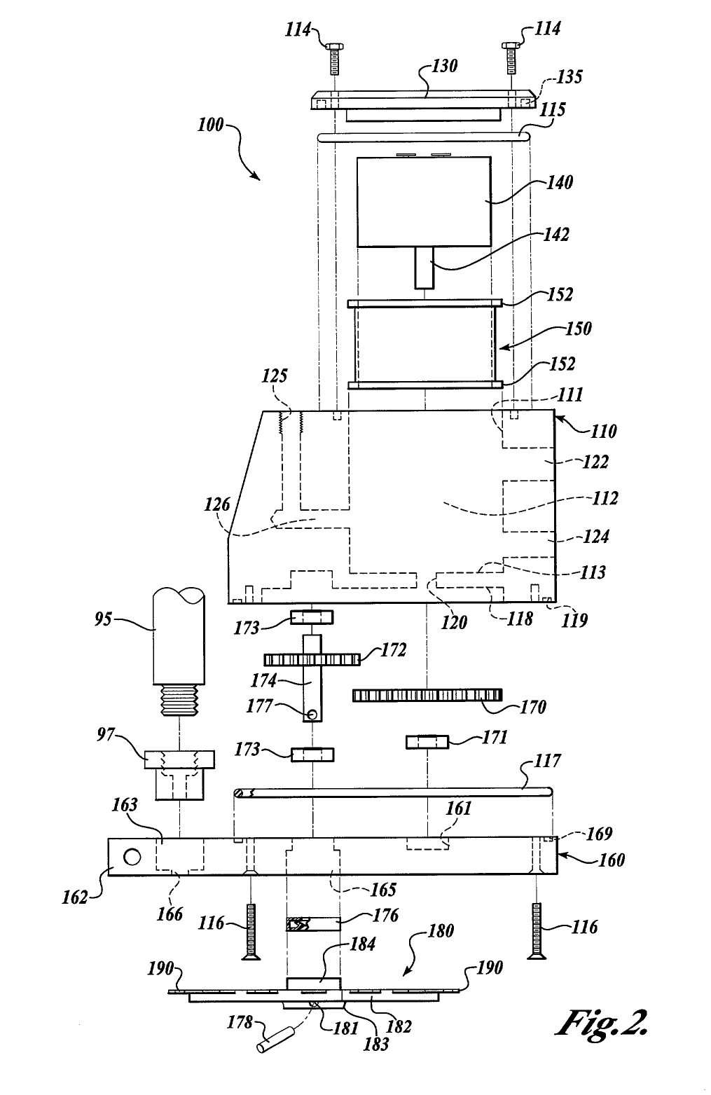

An embodiment of a water blocker, according to the present invention, is shown in cross-section in FIG. 1, and in an exploded view in FIG. 2. The water blocker 100 includes a main housing 110 having a generally cylindrical motor cavity 112 with an open top end 111 and a partially-closed bottom end 113. A cover plate 130 is attached to the main housing 110, over the motor cavity 112. In the preferred embodiment, the cover plate 130 is removably attached to the main housing 110 with a plurality of screws 114, and the cover plate 130 includes a groove 135 to accommodate a sealing device such as an O-ring 115, such that the top end of the motor cavity 111 is substantially sealed when the cover plate 130 is installed. A center circular orifice 120 is provided at the bottom end 113 of the motor cavity 112.

A motor 140, and preferably a stepper motor, is installed in the motor cavity 112. The motor includes a downwardly disposed rotor output shaft 142, that extends out of the motor cavity 112 through the circular orifice 120. A tubular cooling sleeve 150 having a pair of radially projecting end flanges 152 is slidably disposed about, and in thermal contact with, the motor 140. The flanges 152 have an outer diameter approximately equal to, or slightly less than, the inner diameter of the motor cavity 112, thereby forming an annular channel between the cooling sleeve 150 and the inside wall of the motor cavity 112. The cooling sleeve 150 is preferably made from a good thermal conductor, such as aluminum or brass.

The main housing 110 includes an electrical service orifice 122 providing a channel into the motor cavity 112 generally above the motor 140. Power is provided to the motor 140 through electrical wires 90 that enter the motor cavity 112 through the electrical service orifice 122. An air inlet orifice 124 provides another channel into the motor cavity 112. The air inlet orifice 124 is located adjacent the motor 140, such that convective cooling air can be provided in the channel formed by the cooling sleeve 150. An air outlet orifice 126 is located generally opposite the air inlet orifice 124, and provides an outlet for the convective cooling air. In the preferred embodiment the inlet orifice 124 provides a passageway through the main housing 110 terminating with a threaded outlet portion 125 adapted to receive a screw-type fitting 97. Although the disclosed embodiment depicts press-fit connections to the electrical service orifice 122 and the air inlet orifice 124, and a screw-type fitting 97 for the air outlet orifice 126, it will be readily apparent that any conventional type of fitting could be provided at these orifices without departing from the present invention.

The main housing 110 includes a recessed portion 118 at its bottom end, generally below the motor cavity 112. The main housing 110 is attached to a base plate 160, disposed below the main housing 110 with a plurality of screws 116. In the disclosed embodiment, a second O-ring 117 is provided in matching grooves 119, 169 in the main housing 110 and the base plate 160, respectively, to provide a sealed interface between these components. The recessed portion 118 of the main housing 110 and the base plate 160 cooperatively form a gear cavity 164 that is sized to accommodate a master drive gear 170 attached to the rotor shaft 142, and a slave or driven gear 172 that engages, and is driven by, the master drive gear 170. The main housing 110 and the base plate 160 are preferable composed of a high density plastic, such as Delrin®.

The base plate 160 includes a bearing recess 161 disposed directly beneath the rotor shaft 142. A bearing 171 disposed in the bearing recess 161 engages the end of the rotor shaft 142. A stepped bore 165 extends through the base plate 160 at a location below the center of the driven gear 172. The driven gear 172 has a downwardly disposed drive shaft 174 that projects through the bore 165. A bearing 173 is provided in the reduced diameter portion of the bore 165, to slidably receive the drive shaft 174. In the preferred embodiment, a radial lip seal 176 is also provided, beneath the bearing 173.

The base plate 160 fits generally beneath the main housing 110, and includes a laterally projecting portion 162 that extends away from the main housing 110. The projecting portion of the base plate 162 includes a threaded bore 163, that is adapted to receive a high pressure fluid fitting located at the end of a conduit 95. A small aperture 166 is provided in the bottom of the threaded bore 163. The high pressure fluid conduit 95 directs a stream of fluid (not shown) that is directed approximately perpendicular to the base plate 160, and towards the small aperture 166. In the preferred embodiment, an annular disk-shaped carbide insert 167 is provided in the bottom of the threaded orifice 163 to protect the base plate 160 from wear due to the high-speed water stream.

A blocker wheel 180 is attached to the driven gear drive shaft 174. The blocker wheel 180 includes a mounting wheel 182 and a plurality of radially extending blocking pins 190. In the disclosed embodiment the blocking pins 190 are generally rectangular, although any other appropriate shape is also contemplated by the present invention, including, for example, elongate, tapering pins and pins having a narrow proximal portion and a larger distal portion. As the blocker wheel 180 is rotatably driven by the driven gear 172, the blocking pins 190 move along a circular path immediately below the base plate 160, and with the blocking pins 190 very close to the bottom surface of the base plate 160.

As seen most clearly in FIG. 3, which shows a sectional plan view of the water blocker 100, the blocking pins 190 are sized to pass directly beneath the small aperture 166, intersecting and thereby blocking the stream of fluid from the high pressure fluid conduit 95. The motor 140 selectively drives the master drive gear 170, which in turn rotates the driven gear 172, rotating the blocker wheel 180. When the blocker wheel 180 is in the position shown in FIG. 3, the high-speed water jet which is directed towards the small orifice 166 is blocked. A very small rotation of the motor 140 will move the blocking pin 190 away from the small aperture 166, thereby unblocking the high-speed water jet.

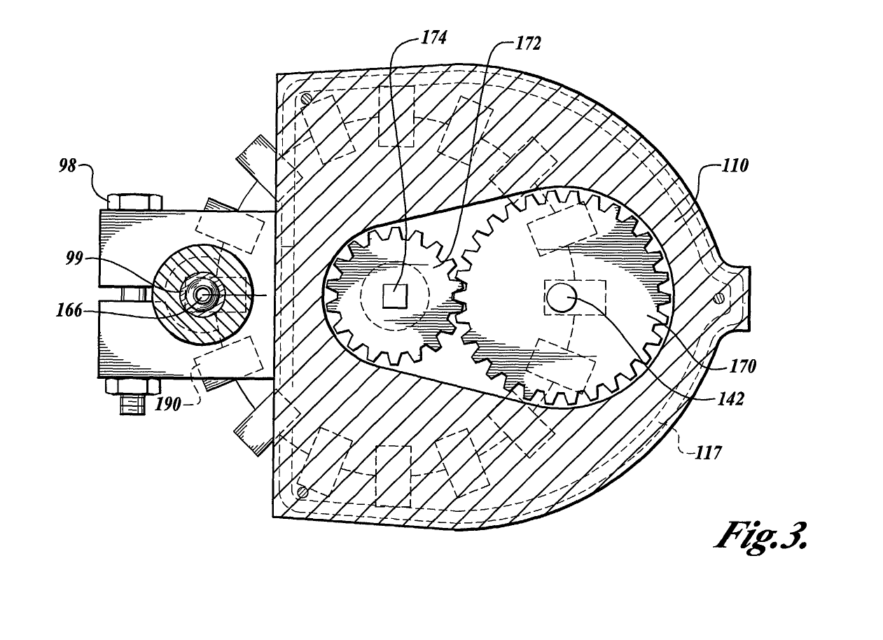

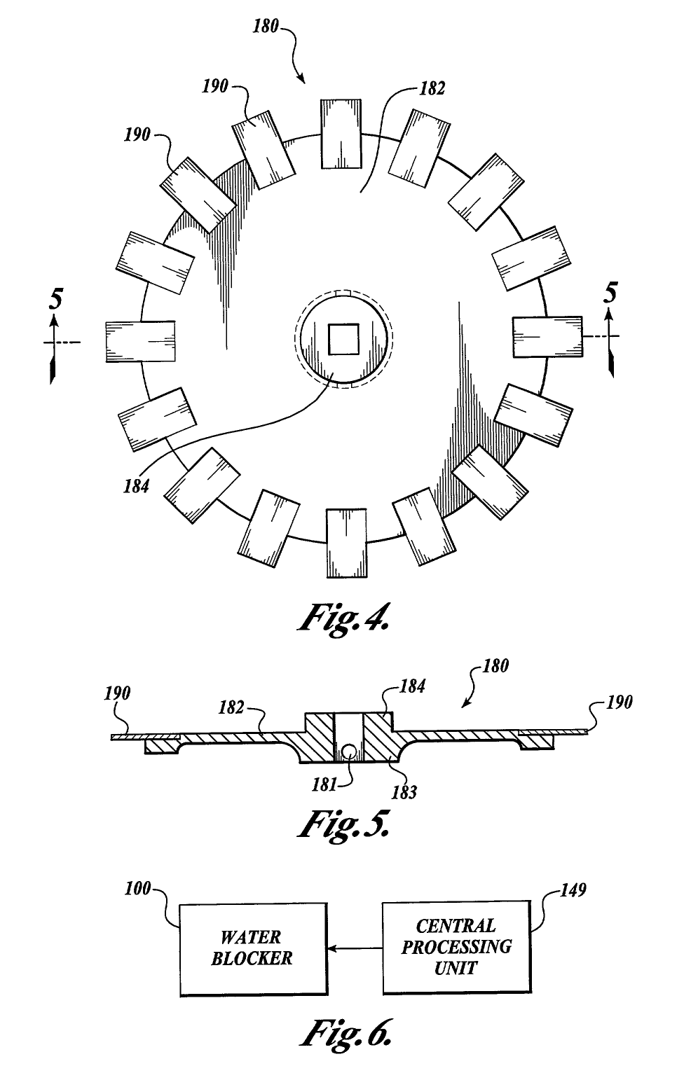

A plan view of the blocker wheel 180 is shown in FIG. 4, and a side cross sectional view is shown in FIG. 5. In the disclosed embodiment, the mounting wheel 182 includes a cylindrical hub section 184 that is slidably inserted part way into the bore 165, thereby helping to maintain the blocker wheel 180 in the correct position. A lower hub portion 183 is provided with a pair of aligned slots or holes 181, that align with a transverse hole 177 in the slave gear drive shaft 174. A pin 178 inserted through the holes 177, 181 attaches the blocker wheel 180 to the drive shaft 174.

The blocking pins 190 may be attached to the mounting wheel 182 in any conventional manner, including for example, by welding, riveting, threaded fasteners, bonding, and/or friction fitting. The material composition of the blocking pins 190 can be important in reducing maintenance time. The blocking pins 190 may be composed of titanium, carbide, or a memory alloy such as a nickel-titanium, all of which are highly resistant to erosion by the high pressure water jet. The blocking pins may alternatively be composed of a carbide core covered with a stainless steel or other alloy cover. Alternatively, a very hard substance, such as a natural or synthetic diamond, could be inlayed into the blocking pins 190 to serve as a wear surface. As used herein, the term blocking pin is intended to mean any member that can be inserted into the fluid stream to block the water jet, such as a rod, pad, tab, plate, and the like.

Although the master drive gear 170 in the depicted embodiment is larger than the driven gear 172, thereby requiring smaller rotor 142 rotations to produce a given blocker wheel 180 rotation, in some applications an opposite gearing may be desirable. Selection of appropriate gearing ratios is within the normal skills of the art. It is also contemplated that the blocker wheel 180 could alternatively be attached directly to the rotor shaft 142 of motor 140, thereby obviating the need for the gears 170, 172.

In the preferred embodiment of the present invention, and best seen in the block diagram presented in FIG. 6, a programmable processing system 149, such as a computer having a central processing unit, is used to control the motor 140. The processing unit 149, with predefined routines, controls an electric signal sent to the motor 140, which moves the blocker wheel 180, thereby controlling the blocking and unblocking of the high-speed water jet. Multiple water blockers can be used in conjunction with a computer controller for performing multiple tasks simultaneously. It is contemplated that either the water blocker 100 or the product being cut, or both, would be positionally controlled to produce the desired cutting function.

It will be appreciated that the present invention allows the motor 140 to be operated in one direction, rather than in an oscillatory manner, which simplifies the motor construction and reduces the wear on the motor, improving system reliability.

It will also be appreciated that the blocker wheel 180 includes a plurality of blocker pins 190 (16 pins are shown in the disclosed embodiment, although more or fewer blocker pins are contemplated by the present invention). The amount of wear to any one blocker pin is correspondingly reduced, requiring less frequent maintenance to the system. Moreover, the blocker wheel 180 is rotated only a short amount to switch between the blocking and the unblocking mode. For evenly-spaced blocking pins, the wheel must rotate only 180/n degrees on average to switch between blocking and unblocking mode, where “n” is the number of blocking pins on the blocking wheel 180. The resulting operation of the motor 150 is therefore reduced, again improving system reliability, and permitting the blocking function to be very rapidly and controllably alternated.

It will be appreciated that the preferred embodiment has been described herein to teach and illustrate the present invention and that many variations in the specific apparatus disclosed may be made and are contemplated by the present invention. The disclosed water blocker 100 is intended for uses requiring a very large number of rapid blocking/unblocking operations, and therefore producing a high demand on the motor 140, which will result in significant heat generation by the motor 140. The invention can also be used in lower-demand applications, however, wherein the demands on the motor are less severe. In such applications the convective air cooling system wherein cooling air is forced past the cooling sleeve 150 may not be required.

Also, although the preferred embodiment utilizes a main housing that encloses the motor and received the high-speed water jet conduit, the water jet could alternatively be provided in alignment with the water jet blocker without being directly attached to the housing.

While the preferred embodiment of the invention has been illustrated and described, it will be appreciated that various changes can be made therein without departing from the spirit and scope of the invention.

The embodiments of the invention in which an exclusive property or privilege is claimed are defined as follows:

1. An apparatus for selectively blocking a high pressure fluid stream, the apparatus comprising:
(a) a motor support structure;
(b) a motor attached to the motor support structure; and
(c) a wheel supporting a plurality of circumferentially arranged blocking members, the wheel being drivably connected to the motor such that rotating the wheel will cause the blocking pins to sequentially intersect the high pressure fluid stream.

2. The apparatus of claim 1, wherein the blocking members comprise pins that extend radially from the wheel.

3. The apparatus of claim 1, wherein the motor support structure comprises a housing having a motor cavity, and wherein the housing is adapted to receive a conduit supplying the high pressure fluid stream, the housing including an aperture aligned with the high pressure fluid stream.

4. The apparatus of claim 3, further comprising a motor cooling system comprising a source of pressurized air fluidly connected through an air inlet port to the motor cavity and an air outlet channel operable to vent the air from the motor cavity.

5. The apparatus of claim 4, wherein the motor cooling system further comprises a tubular cooling sleeve slidably disposed around the motor.

6. The apparatus of claim 5, wherein the tubular cooling sleeve further comprises a pair of outwardly extending flanges disposed at axially spaced-apart locations on the sleeve, the flanges being sized to slidably engage the housing, thereby forming an annular channel between the tubular cooling sleeve and the housing, and wherein the pressurized air inlet port and the air outlet channel are fluidly connected to the annular channel.

7. The apparatus of claim 1, wherein the blocking members are made of carbide.

8. The apparatus of claim 1, wherein the blocking members are made of titanium.

9. The apparatus of claim 1, wherein the blocking members comprise a diamond inlay portion.

10. The apparatus of claim 1, further comprising a programmable controller connected to the motor to control the operation of the motor.

11. An apparatus for intermittently blocking a high-pressure fluid stream from a fluid conduit, the apparatus comprising:
(a) a motor;
(b) a housing assembly including a motor mounting portion adapted to receive the motor and a blocker portion adapted to receive the fluid conduit, the blocker portion having an aperture aligned with the stream of high pressure fluid from the fluid conduit;
(c) a wheel assembly drivably connected to the motor, the wheel assembly having a hub and a plurality of spaced-apart blocking pins extending radially from the hub, wherein the pins are positionable to block the stream of high pressure fluid; and
(d) a programmable controller connected to the motor for selectively blocking and unblocking the stream of high pressure fluid.

12. The apparatus of claim 11, further comprising a convective air cooling system comprising a source of compressed air that is directed to flow generally around the motor.

13. The apparatus of claim 11, wherein the plurality of blocking pins comprise at least 16 blocking pins that are made from carbide.

14. The apparatus of claim 13, wherein the motor is a stepper motor.

15. The apparatus of claim 11, wherein the motor mounting portion of the housing assembly comprises a cavity that sealably encloses the motor.

16. The apparatus of claim 15, wherein the motor mounting portion of the housing includes a compressed air inlet port and an air outlet port, the apparatus further comprising a source of cooling air attachable to the compressed air inlet port.

17. The apparatus of claim 16, further comprising a cylindrical sleeve that is slidably disposed around the motor.

18. The apparatus of claim 11, wherein the wheel assembly is connected to the motor through a gear system comprising a master gear drivably connected to the motor, and a slave gear attached to the wheel assembly and drivably connected to the master gear.

19. A method for blocking the flow of a high pressure fluid stream from a conduit comprising:
aligning the high pressure fluid stream relative to a housing assembly, wherein the housing assembly includes a motor that is drivably connected to a wheel having a plurality of radially extending blocking members that are disposed such that rotating the wheel will move the blocking members through an arc intersecting the high pressure fluid stream; and
controlling the motor to move the blocking pins to selectively block and unblock the high pressure fluid stream.

20. The method of claim 19, wherein the motor is controlled using a programmable computer.

21. The method of claim 19, further comprising the step of cooling the motor with a compressed air stream that flows past the motor to provide convective cooling.

22. The method of claim 21, further wherein the motor is disposed insid a housing that protects the motor from the high pressure fluid stream.

23. The method of claim 22, wherein the motor is drivably connected to the wheel through a gear system comprising a master gear connected to the motor and a slave gear connected to the wheel.
